(19) United States
(12) Patent Application Publication
(10) Pub. No.: US 2018/0077378 A1
(43) Pub. Date: Mar. 15, 2018

(54) IMAGE RECORDER

(71) Applicant: JVC KENWOOD Corporation, Yokohama-shi (JP)

(72) Inventor: Takayuki SATOH, Yokohama-shi (JP)

(21) Appl. No.: 15/702,038

(22) Filed: Sep. 12, 2017

(30) Foreign Application Priority Data
Sep. 13, 2016 (JP) 2016-178165

(51) Int. Cl. H04N 5/76; H04N 5/232

(52) U.S. Cl. CPC H04N 5/76; H04N 5/374; H04N 5/23241

(57) ABSTRACT

This invention provides an image recorder comprising: a camera module for capturing circumstances as electric image data; a sensor for detecting a change of conditions; a recording media for recording the image data output from the camera module; and a processor for deciding a candidate of a predetermined incident having happened or not by comparing output of the sensor with a first threshold lower than a second threshold for deciding an incident as the predetermined incident; and then, in accordance with the result of deciding, making the recording media record the image data into either a first recording area where the image data are allowed to be overwritten or a second recording area where the image data can be temporarily written. This invention also provides an image recording method and a non-transitory computer-readable storage medium storing a computer program executing the image recording method.

### CROSS-REFERENCE TO RELATED APPLICATIONS

The present application claims priority under 35 U.S.C. § 119 to Japanese Patent Application No. 2016-178165, filed on Sep. 13, 2016, the entire content of which are incorporated herein by reference.

### BACKGROUND OF THE INVENTION

### 1. Field of the Invention

This invention relates to an image recorder and an image recording method thereof. This invention may be used especially in a dashboard camera but is not limited.

### 2. Description of Related Art

In a conventional dashboard camera, it is well known to detect an accident by considering a situation where a detected value of an acceleration sensor exceeds a predetermined threshold as an incident such as an accident and to store the previous and next images as write inhibit data. However, it is difficult in practice to detect only an incident that a use wants to record, such as an accident. For example, due to a step or roughness on the road surface or rough driving of the driver, it may happen that the detected value of the acceleration sensor exceeds the threshold and an incident is detected improperly. If the memory is filled by write inhibit date of images for improper incidents which are not desired by the driver, the dashboard camera may not work continuously.

For making a dashboard camera work continuously, PTL 1 discloses, in paragraph 0007, a technique in which two memory cards are used for recording normal images into one of the two memory cards continuously and executing another writing process or the like on the other of the two memory cards.

By using two memory cards, memory capacity is increased to elongate simply the time period for recording. It can improve continuity of a function of a dashboard camera. However, it is not directly satisfied such a problem that improper images not desired by the driver is recorded.

That is, in the technique disclosed in PTL 1, images are recorded regardless the memory capacity even for an incident that the driver does not wont to be detected but the detected value of the acceleration sensor exceeds the threshold as is conventionally done and are not recorded for an incident that the detected value of the acceleration sensor does not exceed the threshold but the driver wants to be detected.

This invention is aimed at solving the above-mentioned problem to provide an image recorder and an image recording method which can detect an incident suitably and work continuously.

### CITATION LIST

### Patent Literature

PTL1: JP 2014-220803 A

### BRIEF SUMMARY OF THE INVENTION

An image recording method of this invention is used in an image recorder comprising a camera module for capturing circumstances as electric image data; a sensor for detecting a change of conditions; a recording media for recording the image data output from the camera module; and a processor; wherein the processor execute: deciding a candidate of a predetermined incident having happened or not by comparing output of the sensor with a first threshold lower than a second threshold for deciding an incident as the predetermined incident; and in accordance with the result of deciding, making the recording media record the image data into either a first recording area where the image data are allowed to be overwritten or a second recording area where the image data can be temporarily written.

An image recorder according to this invention comprises a camera module for capturing circumstances as electric image data; a sensor for detecting a change of conditions; a recording media for recording the image data output from the camera module; and a processor for deciding a candidate of a predetermined incident having happened or not by comparing output of the sensor with a first threshold lower than a second threshold for deciding an incident as the predetermined incident; and then, in accordance with the result of deciding, making the recording media record the image data into either a first recording area where the image data are allowed to be overwritten or a second recording area where the image data can be temporarily written.

An image recorder according to this invention comprises an imaging unit and a sensor to record image data output from the imaging unit into a recording unit. The image recorder further comprises: an incident candidate decision unit for deciding a candidate of a predetermined incident having happened or not based on sensed information supplied from the sensor and a first threshold lower than a second threshold for deciding an incident as the predetermined incident; and a recording control unit for controlling the recording unit in accordance with the decided result of the incident candidate decision unit for the image data to be recorded into any of a first recording area where the image data are allowed to be overwritten, a second recording area where the image data can be temporarily written and a third recording area where the image data are inhibited to be written.

A non-transitory computer-readable storage medium storing a program of this invention is used in an image recorder comprising a camera module for capturing circumstances as electric image data; a sensor for detecting a change of conditions; a recording media for recording the image data output from the camera module; and a processor, to make the processor execute: deciding a candidate of a predetermined incident having happened or not by comparing output of the sensor with a first threshold lower than a second threshold for deciding an incident as the predetermined incident; and in accordance with the result of deciding, making the recording media record the image data into either a first recording area where the image data are allowed to be overwritten or a second recording area where the image data can be temporarily written.

According to this invention, an image recorder in which an incident can be detected suitably and work continuously. This invention also provides an image recording method and a non-transitory computer-readable storage medium storing a computer program executing the image recording method.

### BRIEF DESCRIPTION THE SEVERAL VIEWS OF THE DRAWINGS

Specific embodiments of the present invention will now be described, by way of example only, with reference to the accompanying drawings in which:

FIG. 1A shows a schematic aspect and installation example of a dashboard camera of a first embodiment according to the imaging recorder of this invention.

FIG. 1B shows a front view of the dashboard camera.

FIG. 1C is a bottom view of the dashboard camera.

FIG. 2 shows a block diagram illustrating an example of a hardware configuration of the dashboard camera shown in FIG. 1.

FIG. 3 shows a recording operation in accordance with output of the sensor in the dashboard camera shown in FIG. 1 and FIG. 2

FIG. 4 shows the dashboard camera 1 shown in FIG. 1 and FIG. 2 more detail in each function thereof.

FIG. 5 shows examples of detectable incidents in accordance with sorts of sensors.

FIG. 6 shows an incident candidate decision process executed by the dashboard camera shown in FIG. 1.

FIG. 7 shows an incident decision process executed by the dashboard camera shown in FIG. 1.

FIG. 8 shows a modified flowchart of the decision process executed by the dashboard camera

FIG. 9 shows a flowchart of an incident decision process of the second embodiment of this invention.

### DETAILED DESCRIPTION OF THE INVENTION

In the following descriptions, a term “incident” means an affair where it happens a change of conditions of the vehicle or a periphery of the vehicle. Each incident in the following descriptions is classified as a proper incident which is considered by a user to be recorded or an improper incident which is not considered to be recorded. The “proper incident” may be, exemplary, hitting by another vehicle, scratching by another vehicle, cart or the like, blowing out, breaking of a car window, hitting of a door, stolen of a wheel, hitting of a door mirror or the like but not limited. The “improper incident” may be, exemplary, waggling of the vehicle caused by strong wind, on a bridge or the like, coming close of a moving object, or the like but not limited

### First Embodiment

[Explanation of Hardware Configuration of Dashboard Camera 1]

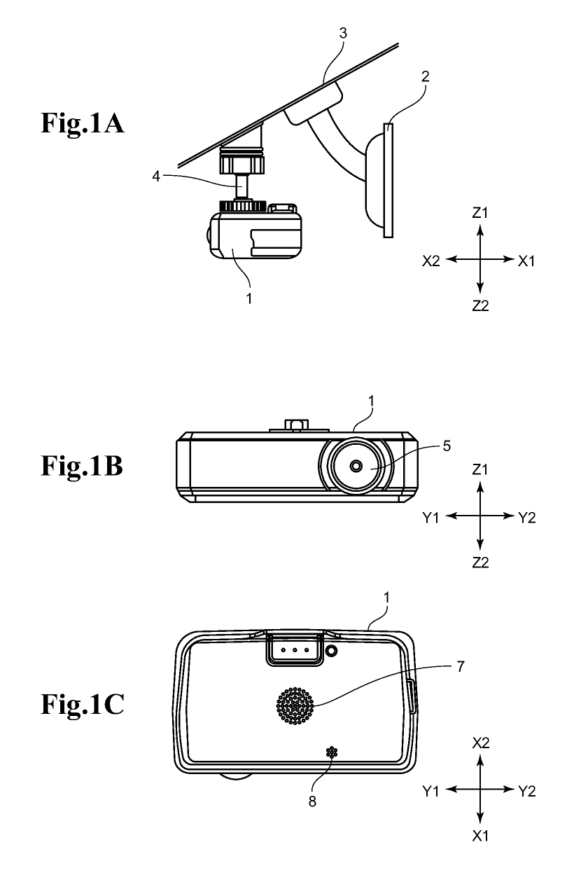

FIG. 1A shows a schematic aspect and installation example of a dashboard camera 1 of a first embodiment according to the imaging recorder of this invention, FIG. 1B is a front view of the dashboard camera 1, and FIG. 1C is a bottom view of the dashboard camera 1. The dashboard camera 1 is to record image data (moving pictures or still images) showing circumferential situations of the vehicle at parked, in driven or the like. The dashboard camera 1 is attached on, as shown in FIG. 1A, a windshield 3 behind the rearview mirror 2 of the vehicle by a mount base 4. In the following descriptions, the direction from the dashboard camera 1 to the rearview mirror 2 is defined as “X1 direction” and the opposite direction as “X2 direction.” Further, the direction from the dashboard camera 1 and the rearview mirror 2 to the windshield 3 is defined as “Z1 direction” and the opposite direction as “Z2 direction.”

The dashboard camera 1 is provided, as shown in FIG. 1B, with a camera lens 5 at the front side. This camera lens 5 is to imaging the front side (in the X2 direction) of the vehicle. In FIG. 1B, the direction from the center of the dashboard camera 1 to camera lens 5 is defined as “Y2 direction” and the opposite direction as “Y1 direction.” On the underside of the dashboard camera 1, a loudspeaker portion 7 and microphone portion 8 are provided as shown in FIG. 1C,

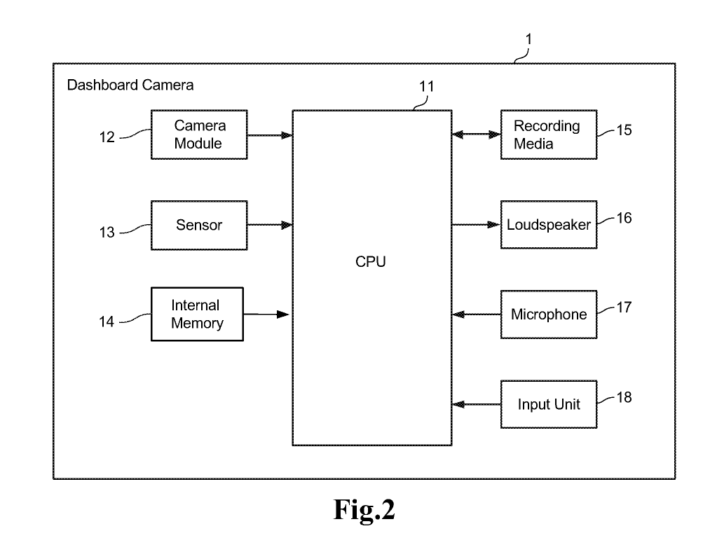

FIG. 2 shows a block diagram illustrating an example of a hardware configuration of the dashboard camera 1 shown in FIG. 1. As shown in FIG. 2, the dashboard camera 1 comprises a CPU (Central Processing Unit) 11 as an example of a processor, a camera module 12 for capturing circumstances as electric image data, a sensor 13 for detecting a change of conditions, an internal memory 14, a recording media 15, a loudspeaker 16, a microphone 17 and an input unit 18.

The CPU 11 is to act in accordance with a control program and control data stored in the internal memory 14 to control each part of the dashboard camera integratedly. The CPU 11 executes the control program stored in the internal memory to realize each function described below.

The camera module 12 may comprise the camera lens 5 shown in FIG. 1 and is provided with a CCD (Charge-Coupled Device) sensor or a CMOS (Complementary Metal Oxide Semiconductor) sensor.

The sensor 13 may be, for example, an acceleration sensor, an angular velocity sensor, a pressure sensor infrared sensor, a proximity sensor, a GPS (Global Positioning System) receiver, a vehicle velocity sensor, or the like. The acceleration sensor is, for example, for detecting accelerations in three axial directions, that is, the X axis (the axis of X1-X2), the Y axis (the axis of Y1-Y2), and the Z axis (the axis of Z1-Z2) shown in FIG. 1 to detect the change of the physical location of the dashboard camera 1. The angular velocity sensor is, for example, for detecting the angle and the angular velocity to detect the physical angle and angular velocity of the dashboard camera 1. The pressure sensor is, for example, for measuring the pressure of a gas or a liquid by means of a pressure sensitive device through a diaphragm and outputting the measured value in an electric signal, to detect the pressure in the vehicle. The infrared sensor is for detecting an object by means of the changing amount of an infrared beam to have been emitted and to be reflected or transmitted, to detect an object near by the vehicle. The proximity sensor is for detecting a detected object coming close to, to detect the object coming close to the vehicle by means of an eddy current, a change of an electric capacitance, a magnet or the like. The GPS receiver detects location information including the latitude, the longitude and the height of the dashboard camera 1. The vehicle velocity sensor detects the velocity of the vehicle by means of the rotation rate of the speed of the wheel axis.

The internal memory 14 comprises an ROM (Read Only Memory), an RAM (Random Access Memory) and the like. The ROM is used for storing the control program to be executed by the CPU 11 and the like. The RAM is used as a working area for the CPU 11 and also as a buffer area for temporally storing driving condition data of the vehicle in a predetermined duration (some seconds to some minutes).

The recording media may comprise a flash memory such as an SD memory card or the like for recording the image data obtained by the camera module 12.

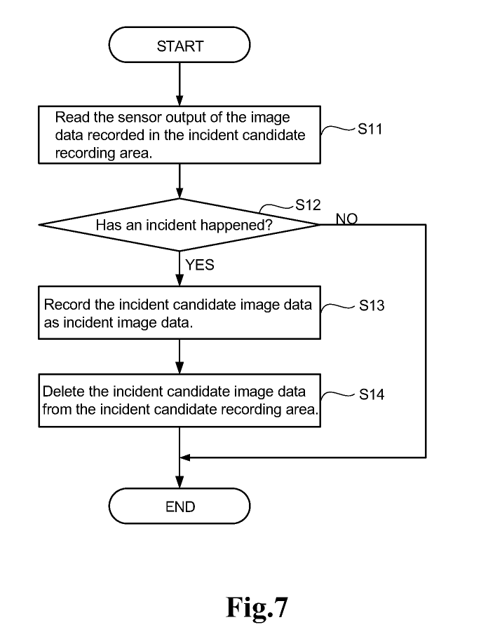

The loudspeaker 16 is provided in the loudspeaker portion 7 shown in FIG. 7 to be able to output playback sound of a recorded file, audio guides, operation sound and the like.

The microphone 17 is provided in the microphone portion 8 to be able to record circumferential sound during recording an image.

The input unit 18 includes physical buttons (not shown) to constitute a human interface for a user to input various kinds of information into the CPU 11.

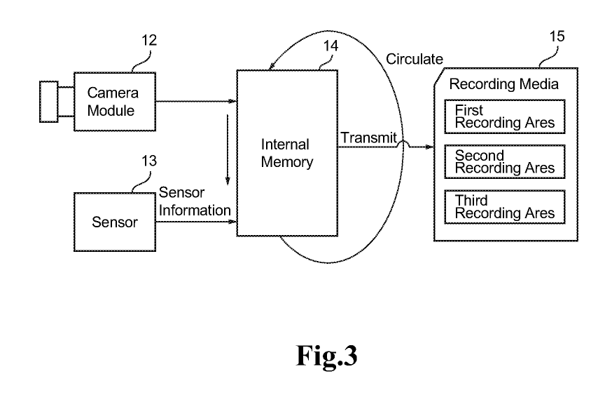

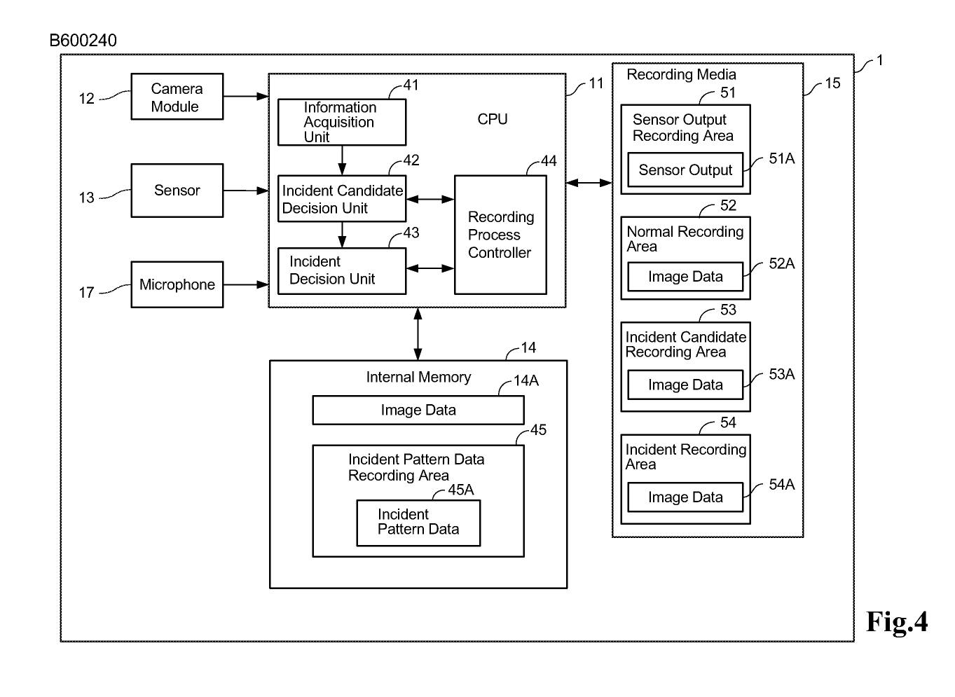

Here is explained recording operation of the dashboard camera 1 shown in FIG. 1 and FIG. 2 at parking monitoring. FIG. 3 shows a recording operation in accordance with output of the sensor in the dashboard camera 1 shown in FIG. 1 and FIG. 2. As shown in FIG. 3, the image data obtained by the camera module 12 are recorded cyclically into a recording area in the internal memory 14. That is, the recording area in the internal memory 14 is filled by the image data in a sequential order from the first logical (or physical) address and when the last logical (or physical) address is filled, the recording point is returned to the first logical (or physical) address on to which the data are over written. During such a cyclic recording is executed, the image data are transmitted to any of a first memory area (a normal recording area 52 in FIG. 4 described later) where the image data are allowed to be overwritten, a second memory area (an incident candidate recording area 53 in FIG. 52 described later) where the image data can be temporarily written and a third memory area (an incident recording area 54 in FIG. 52 described later) where the image data are inhibited to be written.

[Explanation of Functional Configuration of Dashboard Camera 1]

Here are explained functions of the dashboard camera 1. FIG. 4 shows the dashboard camera 1 shown in FIG. 1 and FIG. 2 more detail in each function thereof. The CPU 11 comprises functional blocks of an information acquisition unit 41, an incident candidate decision unit 42, an incident decision unit 43, and recording process controller 44. The internal memory 14 comprises an incident pattern data recording area 45. The recording media 15 comprises a sensor output recording area 51 into which output of the sensor 13 (hereinafter called as “sensor output”) is recorded. The recording media 15 comprises a normal recording area 52 (a first memory area) where the image data are allowed to be overwritten by the recording process controller 44, and an incident candidate recording area 53 (a second memory area) where the image data can be temporarily written by the recording process controller 44. The recording media 15, in this embodiment, further comprises an incident recording area 54 (a third memory area) where the image data are inhibited to be rewritten by the recording process controller 44. The normal recording area 52, the incident candidate recording area 53 and the incident recording area 54 may be provided in a same recording medium with identifying each area logically or provided in a plurality of recording media individually. The dashboard camera 1 may be provided with functions other than the above-mentioned functions.

The information acquisition unit 41 acquires information detected by the camera module 12, the sensor 13, the microphone 17 and the like. That is, the information acquisition unit 41 may acquire, for example, image data captured by the camera module 12, sensor outputs from the sensor 13, and sound signals picked up by the microphone 17. The information acquired by the information acquisition unit 41 is supplied to the incident candidate decision unit 42.

The incident candidate decision unit 42 decides whether a candidate of a predetermined incident, that is a proper incident, has happened or not based on the information supplied from the information acquisition unit 41. Specifically, the incident candidate decision unit 42 decides an incident candidate by comparing output of the sensor 13 with a first threshold lower than a second threshold for deciding an incident as the proper incident. The incident candidate decision unit 42 supplies a decided result thereof to the recording process controller 44. The recording process controller 44 makes the internal memory 14 transmit image data 14A within a predetermined duration before and after the timing at an incident candidate having been decided to the recording media 15 and makes the recording media 15 record the image data 14A into the incident candidate recording area 53. The details of decision process of the incident candidate executed by the incident candidate decision unit 42 will be described later.

The incident decision unit 43 decides whether a predetermined incident has happened for image data 53A which has been decided as an incident candidate, in accordance with information supplied from the information acquisition unit 41. Specifically, the incident decision unit 43 decides whether a proper incident has happened or not by comparing the sensor output with the second threshold which is a decision criterion of the proper incident. The incident decision unit 43 supplies a decided result thereof to the recording process controller 44. The recording process controller 44 moves the image data 53A which has been decided as image date of an incident from the incident candidate recording area 53 to the incident recording area 54. That is, the recording process controller 44 deletes the image data 53A which has been decided as image date of an incident from the incident candidate recording area 53 and makes the incident recording area 54 record the image data 53A. The details of incident decision process executed by the incident e decision unit 43 will be described later.

The recording process controller 44 transmits the image data 14A recorded into the internal memory 14 to the recording media 15 and makes the recording media 15 record the image data 14A. As described above, the recording process controller 44 makes the recording media 15 record the image data 14A in accordance with the decided result of the incident candidate decision unit 42 or the decided result of the incident decision unit 43.

The incident pattern data recording area 45 stores incident pattern data 45A for specifying an incident. The incident pattern data 45A may be, for example, specific information for indicating a behavior of a specific incident and is used as a decision criterion for comparing with a value of the sensor output from the sensor 13. The incident pattern data 45A includes the first threshold (greater than zero) of the sensor output used for deciding a proper incident candidate and the second threshold (greater than the first threshold) of the sensor output used for deciding a proper incident. In the following description, “the second threshold” may be called as “the third threshold” for combining another sensor output.

Here are explained concrete examples of detectable incidents in accordance with sorts of sensors.

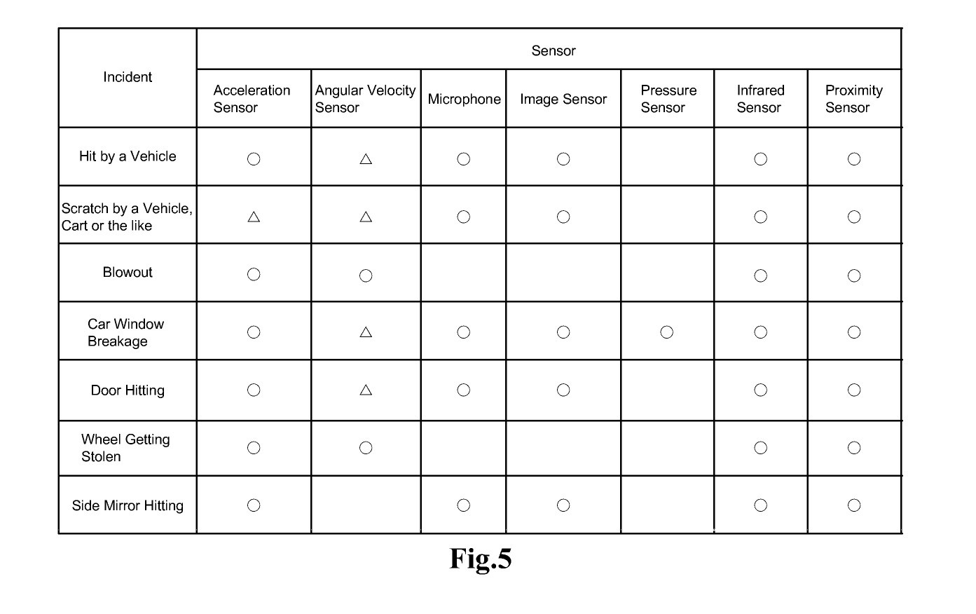

FIG. 5 shows examples of detectable incidents in accordance with sorts of sensors. In FIG. 5, circles indicate that the subject incidents are detectable, triangles indicate that the subject incidents may be detectable with low efficiency, and blank spaces indicate that the subject incidents are not detectable or are difficult to be detected.

As shown in FIG. 5, for example, an acceleration sensor can detect hitting by a vehicle, scratching by a vehicle, cart or the like, blowing out, breaking of a car window, hitting of a door, getting stolen of a wheel or wheels, and hitting of a side mirror, an angular velocity sensor can detect hitting by a vehicle, scratching by a vehicle, cart or the like, blowing out, breaking of a car window, hitting of a door, and getting stolen of a wheel or wheels, a microphone can detect hitting by a vehicle, scratching by a vehicle, cart or the like, breaking of a car window, hitting of a door, and hitting of a side mirror, an image sensor can detect hitting by a vehicle, scratching by a vehicle, cart or the like, breaking of a car window, hitting of a door, and hitting of a side mirror, a pressure sensor can detect breaking of a car window, and an infrared sensor and a proximity sensor can detect hitting by a vehicle, scratching by a vehicle, cart or the like, blowing out, breaking of a car window, hitting of a door, getting stolen of a wheel or wheels, and hitting of a side mirror.

The incident pattern data 45A shown in FIG. 4 may consist of specific information of wave patterns of values to be sensed by these sensors. Since these wave patterns are different for behaviors of incidents, specific wave patterns are stored for each incident.

The sensor output recording area 51 stores the sensor output supplied from the information acquisition unit 41 as sensor output 51A

The normal recording area 52 is a memory area where image data are allowed to be overwritten in the order from old image data when the capacity thereof becomes full. The normal recording area 52 receives the image data 14A during the predetermined duration which is decided as no proper incident has happened for, transmitted from the internal memory 14 by the recording process controller 44, and records as image data 52A. The normal recording area 52 may be arranged to work as the internal memory 14. In such a case, the internal memory may work as a simple buffer area to transmit all captured image data to the normal recording area 52.

The incident candidate recording area 53 is a memory area where image data can be temporarily written. The incident candidate recording area 53 receives the image data 14A during the predetermined duration decided as of an incident candidate, transmitted from the internal memory 14 by the recording process controller 44, and records as image data 53A.

The incident recording area 54 is a memory area where image data are inhibited to be written. The incident recording area 54 receives the image data 53A of an incident candidate, transmitted from the incident candidate recording area 53 by the recording process controller 44, and records as image data 54A.

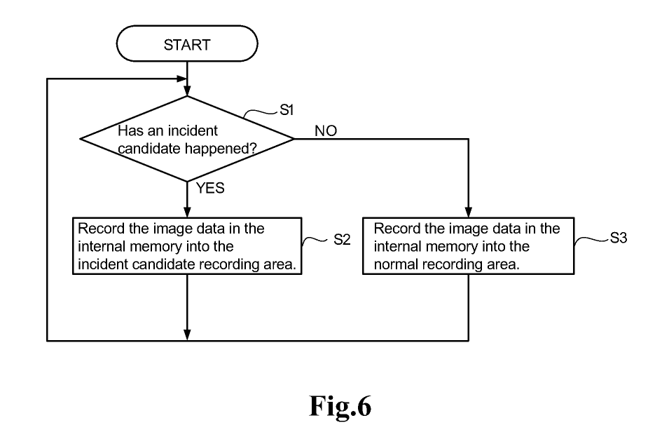

Here are explained processes executed by the CPU 11 with referring flowcharts shown in FIG. 6 and FIG. 7.

FIG. 6 shows a flowchart of an incident candidate decision process executed by the dashboard camera 1 shown in FIG. 1. This process is executed, for example, in parking monitoring when a first condition explained below is satisfied. The first condition may be, for example, engine off detected, sufficient power not supplied, manually instructed as the vehicle is in parking, or the like. The process may be executed in accordance with a combination of these conditions. If the dashboard camera 1 is implemented a power saving function, and the power saving function is working or the dashboard camera 1 is supplied power from the vehicle, the condition where sufficient power is not supplied means, for example, that the engine of the vehicle is off. For executing the process shown in FIG. 6, it should be assumed that the information acquisition unit 41 acquires the sensor output from the sensor 11 and supplies it to the incident candidate decision unit 42

In a step S1, the incident candidate decision unit 42 decides that an incident candidate has happened when the sensor output is decided to exceed the first threshold of the decision criterion of an in incident candidate and supplies the decided result to the recording process controller 44 and the process goes to a step S2.

In the step 2, the recording process controller 44 makes the image data 14A within a predetermined duration before and after the timing when an incident candidate has been decided to have happened be transmitted from the internal memory 14 to the incident candidate recording area 53 of the recording media 15 to be recorded as image data 53A of an incident candidate.

Also in the step S1, if the sensor output is decided to be lower than the first threshold, the incident candidate decision unit 42 decides that no incident candidate has happened and supplies the decided result to the recording process controller 44 and the process goes to a step S3.

In the step S3, the recording process controller 44 makes the image data 14A within a predetermined duration when no incident candidate has been decided to have happened be transmitted from the internal memory 14 to the incident candidate recording area 52 of the recording media 15 to be recorded as normal image data 52A.

The incident candidate decision process mentioned above is executed continuously in parking monitoring and the captured image data are recorded in a predetermined area of the recording media 15 in accordance with the sensor output.

FIG. 7 shows a flowchart of an incident decision process executed by the dashboard camera shown in FIG. 1. This process is executed on an assumption that the image data 53A is recorded in the incident candidate recording area 53 by the incident candidate decision process shown in FIG. 6 and executed when a second condition explained below is satisfied. The second condition may be, for example, that a predetermined duration has expired from an incident candidate is detected, the engine on is detected, sufficient power is supplied, it is manually instructed as the vehicle is in traveling, or the data amount recorded into the incident candidate recording area 53 exceeds a predetermined capacity. The process may be executed in accordance with a combination of these conditions. If the dashboard camera 1 is implemented power saving function, and the power saving function is not working or the dashboard camera 1 is supplied power from the vehicle, the condition where sufficient power is supplied means, for example, that the engine of the vehicle is on.

In a step S11, the incident decision unit 43 read the sensor output 51A of the image data 53 A recorded into the incident candidate recording area 53 from the sensor output recording area 51.

In a Step S12, the incident decision unit 43 decides whether the sensor output 51A read out exceeds the second threshold for deciding the proper incident described above defined by the incident pattern data 45A stored in the incident pattern data recording area 45. When the sensor output 51A is decided to exceed the second threshold, the incident decision unit 43 decides that a proper incident happens. The decided result is supplied to the recording process controller 44 and the process goes to a step S13. If it is decided in the step S13 that no proper incident has happened, the incident decision unit 43 decides that an improper incident has happened and the process finishes.

In the step S13, the recording process controller 44 makes the incident candidate image data 53A decided as a proper incident be transmitted to the incident recording area 54 and make the data be recorded as incident image data 54A.

In the step S14, the recording process controller 44 deletes the image data 53A from the incident candidate recording area 53.

Referring to an example of a proper incident which can be detected in accordance with sorts of sensors shown in FIG. 5, concrete examples of detecting for incident candidates and proper incidents respectively.

[1. Detection of Incident of Hitting by a Vehicle]

Here is explained a concrete example for detecting an incident candidate and a proper incident of hitting by a vehicle in accordance with decision using a same sensor.

If a sensor output detected by an acceleration sensor is decided to exceed a first threshold defined by the incident pattern data 45A for detecting an incident candidate of hitting by a vehicle, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the acceleration sensor among sensor outputs of the incident candidate image data 53A recorded in the incident candidate recording area 53 is decided to be exceed a threshold (second threshold) defined by the incident pattern data 45A for detecting an incident of hitting by a vehicle, the incident decision unit 43 decides that an incident of hitting by a vehicle has happened.

The recording process controller 44 makes the image data 53A decided as of a hitting incident by a vehicle be transmitted to the incident recording area 54 and be recorded as an proper incident image data 54A. The recording process controller 44 also makes the image data transmitted to the incident recording area 54 be deleted from the incident candidate recording area 53.

An concrete example for detecting an incident of hitting by a vehicle in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the angular velocity sensor, the microphone 17, the image sensor, the infrared sensor or the proximity sensor other than the acceleration sensor. If the sensor output of the selected sensor is decided to be exceed a threshold (third threshold) defined by the incident pattern data 45A for detecting an incident of hitting by a vehicle, the incident decision unit 43 decides that an incident of hitting by a vehicle has happened.

The recording process controller 44 makes the incident candidate image data 53A decided as of a hitting incident by a vehicle be transmitted to the incident recording area 54 and be recorded as an proper incident image data 54A. The recording process controller 44 also makes the image data transmitted to the incident recording area 54 be deleted from the incident candidate recording area 53.

[2. Detection of Incident of Scratching by a Vehicle, Cart or the Like]

Here is explained a concrete example for detecting an incident candidate and an incident of scratching by a vehicle, cart of the like.

If the sensor output of the microphone 17 (sound signal), for example, is decided to be exceed a first threshold defined by the incident pattern data 45A for deciding an incident of scratching by a vehicle, cart of the like, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the microphone 17 is decided to be exceed a second threshold defined by the incident pattern data 45A for deciding an incident of scratching by a vehicle, cart of the like, the incident decision unit 43 decides that an incident of scratching by a vehicle, cart or the like has happened.

The recording process controller 44 makes the incident candidate image data 53A decided as of scratching by a vehicle, cart of the like be transmitted to the incident recording area 54 and be recorded as an proper incident image data 54A. The recording process controller 44 also makes the image data transmitted to the incident recording area 54 be deleted from the incident candidate recording area 53.

An concrete example for detecting an incident of scratching by a vehicle, cart of the like e in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the acceleration sensor, the angular velocity sensor, the image sensor, the infrared sensor or the proximity sensor other than the microphone 17. If the sensor output of the selected sensor is decided to be exceed a third threshold defined by the incident pattern data 45A for detecting an incident of scratching by a vehicle, cart of the like, the incident decision unit 43 decides that an incident of scratching by a vehicle, cart or the like has happened.

The recording process controller 44 makes the incident candidate image data 53A decided as of an incident of scratching by a vehicle, cart of the like be transmitted to the incident recording area 54 and be recorded as an proper incident image data 54A. The recording process controller 44 also makes the image data transmitted to the incident recording area 54 be deleted from the incident candidate recording area 53.

[3. Detection of Incident of Blowout]

Here is explained a concrete example for detecting an incident candidate and an incident of blowout.

If the sensor output of the acceleration sensor, for example, is decided to be exceed a first threshold defined by the incident pattern data 45A for deciding an incident of blowout, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of acceleration sensor is decided to be exceeded a second threshold defined by the incident pattern data 45A for deciding an incident of blowout, the incident decision unit 43 decides that an incident of blowout has happened.

The recording process controller 44 makes the incident candidate image data 53A decided as of blowout be transmitted to the incident recording area 54 and be recorded as an proper incident image data 54A. The recording process controller 44 also makes the image data transmitted to the incident recording area 54 be deleted from the incident candidate recording area 53.

Here is descried a specific example for detecting an incident of hitting by a vehicle in accordance with decisions using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the angular velocity sensor, the infrared sensor or the proximity sensor other than the acceleration sensor. If the sensor output of the selected sensor is decided to be exceeded a second threshold defined by the incident pattern data 45A for blowout, the incident decision unit 43 decides that an incident of blowout has happened.

The recording process controller 44 makes the incident candidate image data 53A decided as of an incident near blowout be transmitted to the incident recording area 54 and be recorded as a proper incident image data 54A. The recording process controller 44 also makes the image data transmitted to the incident recording area 54 be deleted from the incident candidate recording area 53.

[4. Detection of Incident of Car Window Breakage]

Here is explained a specific example for detecting an incident candidate and an incident of car window breakage.

If the sensor output of the acceleration sensor, for example, is decided to be exceed a first threshold defined by the incident pattern data 45A for deciding an incident of car window breakage, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the acceleration sensor is decided to be exceeded a second threshold defined by the incident pattern data 45A for deciding an incident of car window breakage, the incident decision unit 43 decides that an incident of car window breakage has happened.

The recording process controller 44 makes the incident candidate image data 53A decided as of car window breakage be transmitted to the incident recording area 54 and be recorded as a proper incident image data 54A. The recording process controller 44 also makes the image data transmitted to the incident recording area 54 be deleted from the incident candidate recording area 53.

Here is explained a specific example for detecting an incident of car window breakage in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the angular velocity sensor, the microphone 17, the image sensor, the pressure sensor, the infrared sensor or the proximity sensor other than the acceleration sensor. If the sensor output of the selected sensor is decided to be exceed a third threshold defined by the incident pattern data 45A for detecting an incident of car window breakage, the incident decision unit 43 decided that an incident of car window breakage has happened.

The recording process controller 44 makes the incident candidate image data 53A decided as of an incident of car window breakage be transmitted to the incident recording area 54 and be recorded as an proper incident image data 54A. The recording process controller 44 also makes the image data transmitted to the incident recording area 54 be deleted from the incident candidate recording area 53.

[5. Detection of Incident of Door Hitting]

Here is explained a specific example for detecting an incident candidate and an incident of door hitting.

If the sensor output is decided to be exceeded a first threshold defined by the incident pattern data 45A for deciding an incident of door hitting, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the acceleration sensor decided to be exceed a second threshold defined by the incident pattern data 45A for deciding an incident of door hitting, the incident decision unit 43 decides that an incident of door hitting has happened.

The recording process controller 44 makes the incident candidate image data 53A decided as of door hitting be transmitted to the incident recording area 54 and be recorded as an proper incident image data 54A. The recording process controller 44 also makes the image data transmitted to the incident recording area 54 be deleted from the incident candidate recording area 53.

Here is explained a specific example for detecting an incident of door hitting in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the angular velocity sensor, the microphone 17, the image sensor, the infrared sensor or the proximity sensor other than the acceleration sensor. If the sensor output of the selected sensor is decided to be exceed a third threshold defined by the incident pattern data 45A for detecting an incident of door hitting, the incident decision unit 43 decides that an incident of hitting by a vehicle has happened.

The recording process controller 44 makes the incident candidate image data 53A decided as of an incident of door hitting be transmitted to the incident recording area 54 and be recorded as an proper incident image data 54A. The recording process controller 44 also makes the image data transmitted to the incident recording area 54 be deleted from the incident candidate recording area 53.

[6. Detection of Incident of Wheel Getting Stolen]

Here is explained a specific example for detecting an incident candidate and an incident of wheel getting stolen.

If the sensor output is decided to be exceeded a first threshold defined by the incident pattern data 45A for deciding an incident of wheel getting stolen, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the acceleration sensor is decided to exceed a second threshold defined by the incident pattern data 45A for deciding an incident of wheel getting stolen, the incident decision unit 43 decides that an incident of wheel getting stolen has happened.

The recording process controller 44 makes the incident candidate image data 53A decided as of wheel getting stolen be transmitted to the incident recording area 54 and be recorded as a proper incident image data 54A. The recording process controller 44 also makes the image data transmitted to the incident recording area 54 be deleted from the incident candidate recording area 53.

Here is explained a specific example for detecting an incident of wheel getting stolen in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the angular velocity sensor, the infrared sensor or the proximity sensor other than the acceleration sensor. If the sensor output of the selected sensor is decided to be exceed a third threshold defined by the incident pattern data 45A for detecting an incident of wheel getting stolen, the incident decision unit 43 decides that an incident of wheel getting stolen has happened.

The recording process controller 44 makes the incident candidate image data 53A decided as of an incident of wheel getting stolen be transmitted to the incident recording area 54 and be recorded as an proper incident image data 54A. The recording process controller 44 also makes the image data transmitted to the incident recording area 54 be deleted from the incident candidate recording area 53.

[7. Detection of Incident of Side Mirror Hitting]

Here is explained a concrete example for detecting an incident candidate and an incident of side mirror hitting.

If the sensor output is decided to exceed a first threshold defined by the incident pattern data 45A for deciding an incident of side mirror hitting, the incident candidate decision unit 42 decides that an incident candidate has happened. The recording process controller 44 makes the image data 14A within the predetermined duration before and after the timing when the incident candidate has been decided to have happened be transmitted from the internal memory 14 to the incident candidate recording area 53 of the recording media 15 and makes the image data 14A be recorded as incident candidate image data 53A.

If the sensor output of the acceleration sensor is decided to be exceeded a second threshold defined by the incident pattern data 45A for deciding an incident of side mirror hitting, the incident decision unit 43 decides that an incident of side mirror hitting has happened.

The recording process controller 44 makes the incident candidate image data 53A decided as of side mirror hitting be transmitted to the incident recording area 54 and be recorded as a proper incident image data 54A. The recording process controller 44 also makes the image data transmitted to the incident recording area 54 be deleted from the incident candidate recording area 53.

Here is explained a specific example for detecting an incident of side mirror hitting in accordance with decision using different sensors. Since the incident candidate decision by the incident candidate decision unit 42 is same with the process mentioned above, here is explained only the process of the incident decision unit 43 executed after the process of the incident candidate decision unit 42.

The incident decision unit 43 selects at least one of the microphone 17, the image sensor, the infrared sensor or the proximity sensor other than the acceleration sensor. If the sensor output of the selected sensor is decided to be exceed a third threshold defined by the incident pattern data 45A for detecting an incident of side mirror hitting, the incident decision unit 43 decides that an incident of side mirror hitting has happened.

The recording process controller 44 makes the incident candidate image data 53A decided as of an incident of side mirror hitting be transmitted to the incident recording area 54 and be recorded as an proper incident image data 54A. The recording process controller 44 also makes the image data transmitted to the incident recording area 54 be deleted from the incident candidate recording area 53.

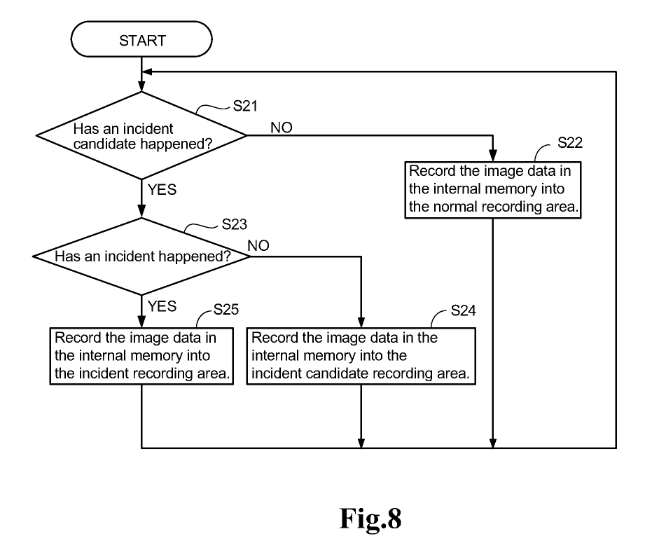

Here is explained a modified example of the incident candidate decision process and the incident decision process. The incident candidate decision process shown in FIG. 6 and the incident decision process shown in FIG. 7 have been explained as executed in the different timing while, in this modified embodiment, the incident candidate decision process shown and the incident decision process are executed in a same timing. FIG. 8 shows a modified flowchart of the decision process executed by the dashboard camera shown in FIG. 1. This process is executed in parking monitoring.

In a step S21, if the value of the sensor output is decided as equal to or lower than the first threshold, the incident candidate decision unit 42 decides that an incident candidate has not happened, supplies the decided result to the recording process controller 44, and the process goes to step S22.

In the step S22, the recording process controller 44 makes the image data 14A within duration decided as no incident candidate has happened be transmitted from the internal memory 14 to the normal recording area 52 of the recording media 15 and be recorded as a normal image data 52A.

In the step S21, if the sensor output is decided as exceed the threshold, the incident candidate decision unit 42 decides an incident candidate has happened, supplies the decided result to the incident decision unit 43, and the process goes to a step S23.

In the step S23, the incident decision unit 43 decides whether the sensor output within the predetermined duration before and after the timing when an incident candidate is decided to have happened exceeds the second threshold for deciding the proper incident defined by the incident pattern data 45A stored in the incident pattern data recording area 45. If it is decided that no proper incident has happened, the incident decision unit 43 supplied the decided result to the recording process controller 44 and the process goes to a step S24.

In the step S24, the recording process controller 44 makes the image data 14A within the predetermined duration before and after the timing when an incident has been decided to have happened transmit from the internal memory 14 to the incident candidate recording area 5 and make the data be recorded as incident candidate image data 53A.

In the step S23, if it is decided that a proper incident has happened, the incident decision unit 43 supplies the decided result to the recording process controller 44 and the process goes to a step S25.

In the step S25, the recording process controller 44 makes the incident candidate image data 53A decided as of a proper incident transfer to the incident recording area 54 and record the data as an incident image data 54A.

The modified decision process described above is executed in parking monitoring to record an image data captured into the predetermined area of the recording media 15 in accordance this sensor output. In this description, the term “in parking monitoring” means, for example, a duration from detection of the engine of the vehicle becoming off to detection of the engine becoming on, a duration from a condition where power is not supplied sufficiently to another condition where power is supplied sufficiently, or a duration form receiving an indication of the vehicle being in parking to receiving an indication of the vehicle being in traveling.

### Second Embodiment

Here is described a second embodiment according to this invention. The dashboard camera 1 of the second embodiment according to this invention can execute, in addition to the incident decision process of a proper incident or an improper incident by a specific decision method, decision of a proper incident by another decision method. For example, in the first embodiment, an proper incident or an improper incident is decided from an incident candidate by means of a predetermined threshold. These incidents may be decided with, in addition to the decision method based on a threshold, a decision method based on another criterion.

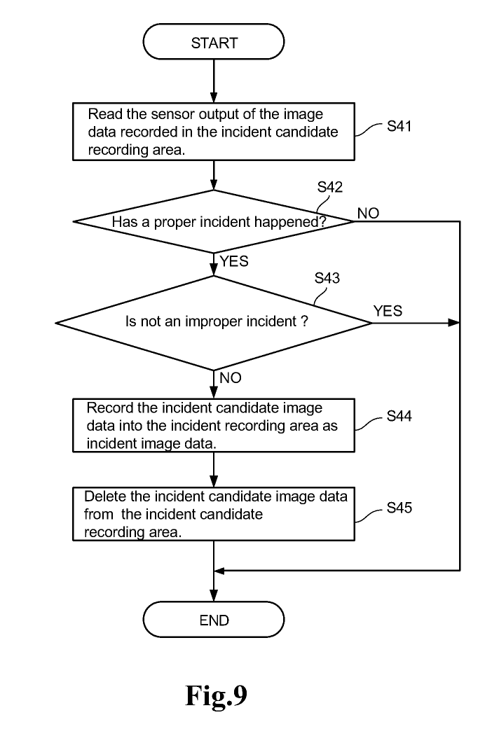

FIG. 9 shows a flowchart of an incident decision process of this embodiment. This process is executed on an assumption that the image data 53A is recorded in the incident candidate recording area 53 by the incident candidate decision process shown in FIG. 6 and executed, for example, when a predetermined duration elapse from detection of an incident candidate, when it is detected the engine becoming on, when power is sufficiently supplied, when an indication of the vehicle in traveling is received, or when the amount of recorded data in the incident candidate recording area 53 exceeds a predetermined capacity.

In a step S41, the incident decision unit 43 reads out a sensor output 51A of an image data 53A recorded in the incident candidate recording area 53 from the sensor output recording area 51.

In a step S42, the incident decision unit 43 decides whether the read out sensor information 51A exceeds the second threshold for deciding the proper incident described above defined by the incident pattern data 45A stored in the incident pattern data recording area 45. If it is decided that the sensor information 51A exceeds the second threshold (“Yes” on the step S42), it is decided in this embodiment that a proper incident has happened and the process goes to a step S43. If is decided that the threshold is not exceeded and the process finishes.

In the step S43, the incident decision unit 43 decides an incident by comparing the read out sensor information 51A with a criterion different from the second threshold for deciding a proper incident mentioned above. That is, the incident decided as proper is judged again whether it is not an improper incident. For example, when the second threshold is an acceleration value detected by an acceleration sensor in a predetermined direction, the different criterion may be for discriminating likelihood of an acceleration waveform detected by an acceleration sensor in a predetermined duration. In this case, the acceleration waveform, which is read out sensor information 51A, is discriminated whether it is similar to a predetermined waveform defined by the incident pattern data 45A. If it is discriminated as similar, the incident decision unit 43 decides that it is not a improper incident (“Yes” on step S43) and the process goes to a step S44. If it is discriminated as not similar, the incident decision unit 43 decides the incident is improper (“No” on step S44) and the process finishes. Likelihood can be calculated by any kind of known art.

In the step S44, the recording process controller 44 makes the incident candidate image data 53A decided as of a proper incident be transmitted to the incident recording area 54 and be recorded as an incident image data 54A.

In a step S45, the recording process controller 44 makes the image data 53A be deleted from the incident candidate recording area 53 and the process finishes.

The dashboard camera 1 of the above-described embodiment is configured to decide whether a candidate of a predetermined incident has happened or not based on sensor output supplied from the sensor 13 and a threshold (first threshold) lower than a threshold (second threshold) for deciding an incident as the predetermined incident. If it is decided that an incident candidate has happened, the dashboard camera 1 further decides the sensor output exceeding the threshold for deciding an incident as the predetermined incident. According to the result of the two decisions, the dashboard camera 1 records image data into any of the normal recording area 52 (first memory area) where the image data are allowed to be overwritten, the incident candidate recording area 53 (second memory area) where the image data can be temporarily written and the incident recording area 54 (third memory area) where the image data are inhibited to be written.

According to such a configuration, for example, the dashboard camera 1 can record image data which is presumed to be leaved, such as image date decided as of an incident candidate or as of an incident, into a temporarily recording area or a write inhibit recording area and allocate image data which is not presumed to be leaved to an recording area allowed to be overwritten. Since the dashboard camera 1 can move image data among the recording areas gradually in accordance with the three possibility of image data being not of any incident, being of a predetermined incident candidate or being of a predetermined incident, image data with a higher possibility of being an incident can leave longer in this device, regardless detection accuracy of the sensor or accuracy of the predetermined incident pattern, compared with a convention method using two memory areas in an internal memory and an SD memory card or using respective memory areas in two SD memory cards for deciding an incident.

Since the dashboard camera 1 is configured to record image date into an overwrite allowed record area if it is not decided as of an incident candidate and into a temporarily recording area if it is decided as of an incident candidate for improving the function of a dashboard camera (continuous monitoring function), image data can be recorded if it is difficult to decide whether a predetermined incident has happened, if it is detected that the sensor output is lower than the specific amount for a predetermined incident or if the incident cannot defied uniformly.

Since the dashboard camera 1 is configured to store sensor output from the sensor is stored in a predetermined duration as well as to execute incident decision in accordance with the sensed information within the predetermined duration of the incident candidate image data 53A stored in the temporary recordable incident candidate recording area 53 (second recording area) and to record the incident candidate image data newly into the incident recording area 54 (third recording area) if it is detected that a predetermined incident has happed, image data which is really to be stored can be moved to the write inhibit memory area. If the sensed information is not exceed the specific amount, since the image data leaves in the incident candidate recording area 53, a use can refer the data after the fact.

In the dashboard camera 1, the accuracy of the incident decision can be improve by executing multiple in different criteria.

In the dashboard camera 1, power consumption in a poor power supply condition can be reduced by executing the incident decision in a predetermined condition to execute the process when power supply is sufficient.

Although the incident candidate recording are 53 is described as a temporary recording area, if image data is moved into the incident recording area 54, the recording process controller 44 can delete the corresponding image data 53A in the incident candidate recording are 53 or cyclically over write data in the incident candidate recording are 53 in the similar manner with the normal recording area 52.

In the above description, it is assumed that the memory capacities of the normal recording area 52, the incident candidate recording area 53 and the incident recording area 54 of the recording media 15 are set as predetermined values. The proportions of the memory capacities for each recording area can be adjusted by the CPU 11 by monitoring the data amounts of each recording area in the recording media 15.

The embodiments of this invention are described above. This invention is not to restricted by the above embodiments and possible to take various modification without exceeding the scope of this invention. For example, the timing for executing incident decision for the image data recorded as of an incident candidate by another sensor than that of referred at decision of the incident candidate may be at the engine starting. Since the dashboard camera is driven by a battery of the vehicle, it is preferred to make the dashboard camera not execute any operation or not use electricity in the circuitry for saving the power. That is, the decision processes are executed only by the threshold of the sensor for saving power consumption in parking and accurate decisions with consuming power is preferable to be executed after the engine started. That is, different sensors and decision means can be used for incident decision in parking and incident decision in the engine on.

At least some of the functions of the CPU 11, such as the incident candidate decision unit 42, incident decision unit 43, the recording process controller 44, and/or the recording process controller may be embodied by another processor such as a PLD (programmable logic device) including an FPLA (field-programmable logic array), a dedicated hardware or the like. The CPU 11 may be configured by two or more CPUs for executing some of the functions individually.

In a case where the CPU 11 of the dashboard camera 1 comprises a main CPU and a subsidiary CPU, it can make the main CPU sleep and the subsidiary CPU for monitoring and minimum sensors and circuitry operate and only when a sensor if detect an incident candidate, make the main CPU work to start imaging and recording. If the dashboard camera is supplied power by a cigarette socket, or by the battery of the vehicle for the own battery, the normally recorded area (the first recording area where over writing is allowed) is not used for recording and only the area for recording incident candidates and incident (overwrite inhibit) may be used for recording. According to this, recording of image data is started on the sensor detecting in parking and is stopped on the other condition. In this case, the threshold for recording image data may be same with the first threshold or not.

The sequence of process described can be executed by a hardware or a software. For executing the sequence of the process, a computer program constituting the software is installed into a computer embedded a dedicated hardware or a general purpose computer which can execute various sorts of functions by installing various sort of computer program through a non-transitory computer-readable storage medium. The computer program may be one in which the process is executed in the order described above chronologically or another in which the process is executed at necessary timing such as called.

What is claimed is:

1. An image recorder comprising:
a camera module for capturing circumstances as electric image data;
a sensor for detecting a change of conditions;
a recording media for recording the image data output from the camera module; and
a processor for deciding a candidate of a predetermined incident having happened or not by comparing output of the sensor with a first threshold lower than a second threshold for deciding an incident as the predetermined incident; and then, in accordance with the result of deciding, making the recording media record the image data into either a first recording area where the image data are allowed to be overwritten or a second recording area where the image data can be temporarily written.

2. The image recorder according to claim 1 wherein:
the processor is configured to make the recording media:
record the image data into the first recording area if it is decided that no candidate has happened, and
record the image data into the second recording area as incident candidate image data if it is decided that a candidate has happened.

3. The image recorder according to claim 2:
the processor further configured to, when a predetermined condition is satisfied, decide whether a predetermined incident has happened or not by comparing the output of the sensor with the second threshold, and if it is decided the predetermined incident has happened, make the recording media record the incident candidate image data into a third recording area where data are inhibited to be rewritten.

4. The image recorder according to claim 2 wherein: the processor further decides whether an incident has happened or not in accordance with criteria different from the second threshold.

5. The image recorder according to claim 3 wherein: the predetermined condition is either that an engine of the vehicle supplying power to the image recorder starts, or that a function lowering the power consumed by the image recorder is released.

6. The image recorder according to claim 4 wherein: the predetermined condition is either that an engine of the vehicle supplying power to the image recorder starts, or that a function lowering the power consumed by the image recorder is released.

7. An image recording method used in an image recorder comprising a camera module for capturing circumstances as electric image data; a sensor for detecting a change of conditions; a recording media for recording the image data output from the camera module; and a processor; wherein the processor execute:
deciding a candidate of a predetermined incident having happened or not by comparing output of the sensor with a first threshold lower than a second threshold for deciding an incident as the predetermined incident; and
in accordance with the result of deciding, making the recording media record the image data into either a first recording area where the image data are allowed to be overwritten or a second recording area where the image data can be temporarily written.

8. A non-transitory computer-readable storage medium storing a computer program to be installed into an image recorder comprising a camera module for capturing circumstances as electric image data; a sensor for detecting a change of conditions; a recording media for recording the image data output from the camera module; and a processor; to make the processor execute:
deciding a candidate of a predetermined incident having happened or not by comparing output of the sensor with a first threshold lower than a second threshold for deciding an incident as the predetermined incident; and
in accordance with the result of deciding, making the recording media record the image data into either a first recording area where the image data are allowed to be overwritten or a second recording area where the image data can be temporarily written.
